(19) United States
(12) Patent Application Publication
(10) Pub. No.: US 2009/0030267 A1
(43) Pub. Date: Jan. 29, 2009

(54) Sow stimulation saddle

(76) Inventors: Jerome Mack, Leola, SD (US); Scott Shultz, Granite Falls, MN (US)

Correspondence Address: Attn: Jeffrey A. Proehl;Woods Fuller Shultz & Smith PC, 300 South Phillips Avenue, Suite 300, P.O. Box 5027, Sioux Falls, SD, 57117-5027, US

(21) Appl. No.: 11/446,723

(22) Filed: Jun. 5, 2006

(51) Int. Cl. A61D 19/00

(52) U.S. Cl. 600/33

(57) ABSTRACT

A sow stimulation saddle system for stimulating a sow during artificial insemination is disclosed, and comprises a saddle for placing over a section of the loin of a sow for encompassing a portion of the loin. The saddle has a medial section between a pair of side sections, and each of the side sections has a lower end. The system also includes an actuation structure on the saddle for moving the lower ends of the side sections of the saddle inwardly and outwardly with respect to each other.

### BACKGROUND OF THE INVENTION

1. Field of the Invention

The present invention relates to artificial insemination in swine, and more particularly pertains to a new sow stimulation saddle for facilitating the artificial insemination process in a sow by making the process feel more natural to the sow.

2. Description of the Prior Art

The use of devices to enhance the effectiveness of artificial insemination processes on sow is known. However, the known devices appear to have limitations in their effectiveness, in that they do not provide a high degree of stimulation of the sow that is experienced by a sow during a natural mating. More specifically, devices such as belts and weighted saddles and pressure devices have been employed to apply a steady, unvarying amount of pressure to the flanks of the sow during the insemination in an effort to simulate the legs of the mounted board. However, these static devices are less than desirable, in that none of the movement experienced during a natural mating is imparted to the sow by the known device.

Therefore, it is believed that there is a need for an insemination aid that provides a more natural, and less static, experience for the sow that will stimulate the natural processes inside the sow for accepting the semen and producing a more successful insemination.

### SUMMARY OF THE INVENTION

In view of the foregoing disadvantages inherent in the known types of sow stimulation devices now present in the prior art, the present invention provides a new sow stimulation saddle construction wherein the same can be utilized for facilitating the artificial insemination process in a sow by making the process feel more natural to the sow.

To attain this, the present invention generally comprises a sow stimulation saddle system for stimulating a sow during artificial insemination. The sow insemination saddle system may include a saddle for placing over a section of the loin of a sow for encompassing a portion of the loin, with the saddle having a medial section between a pair of side sections and each of the side sections having a lower end. The system also includes an actuation structure on the saddle for moving the lower ends of the side sections of the saddle inwardly and outwardly with respect to each other.

There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

A significant advantage of the present invention is the ability to apply active and realistic pressure to the sow during the insemination to further enhance the naturalness of the process for the sow, to stimulate the natural processes taking place in the sow and increase the changes for a successful insemination.

Further advantages of the invention, along with the various features of novelty which characterize the invention, are pointed out with particularity in the claims annexed to and forming a part of this disclosure. For a better understanding of the invention, its operating advantages and the specific objects attained by its uses, reference should be made to the accompanying drawings and descriptive matter in which there are illustrated preferred embodiments of the invention.

### BRIEF DESCRIPTION OF THE DRAWINGS

The invention will be better understood and objects of the invention will become apparent when consideration is given to the following detailed description thereof. Such description makes reference to the annexed drawings wherein:

FIG. 1 is a schematic top front perspective view of a new sow stimulation saddle according to the present invention.

FIG. 2 is a schematic top view of the present invention.

FIG. 3 is a schematic rear view of the present invention.

FIG. 4 is a schematic front view of the present invention.

FIG. 5 is a schematic right side view of the present invention.

FIG. 6 is a schematic left side view of the present invention.

### DESCRIPTION OF PREFERRED EMBODIMENTS

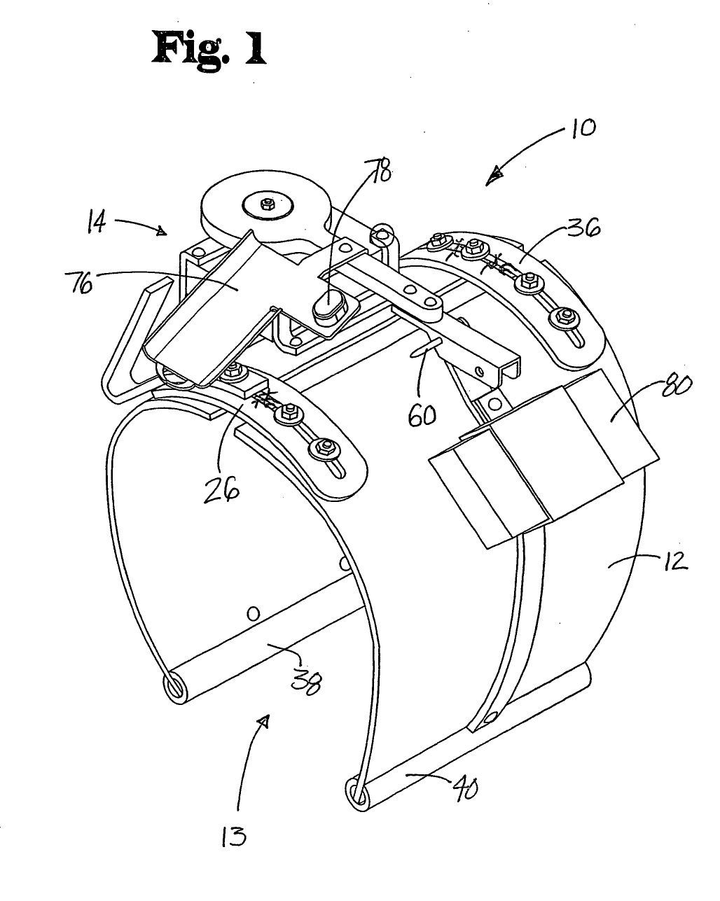

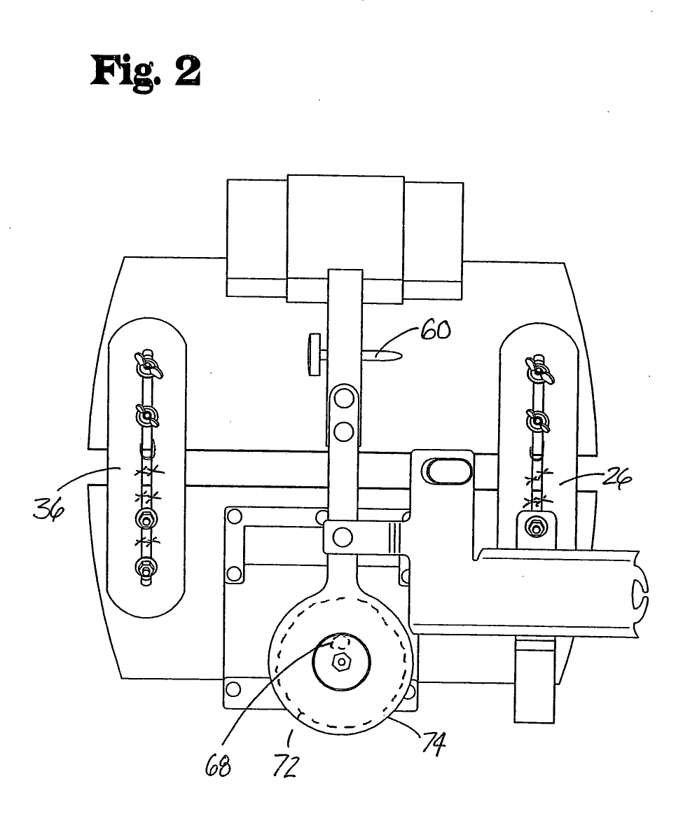

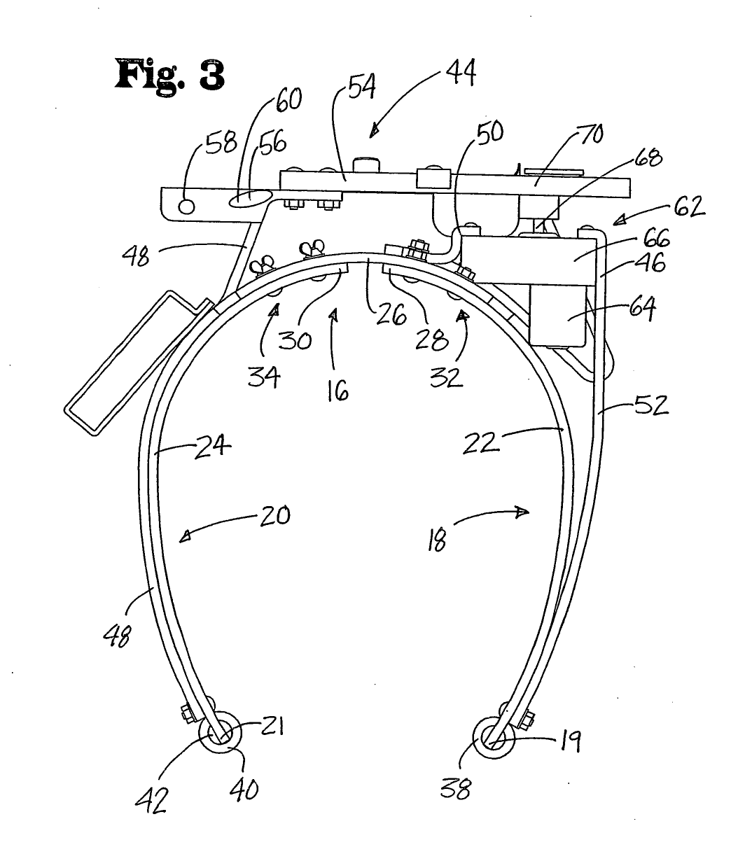

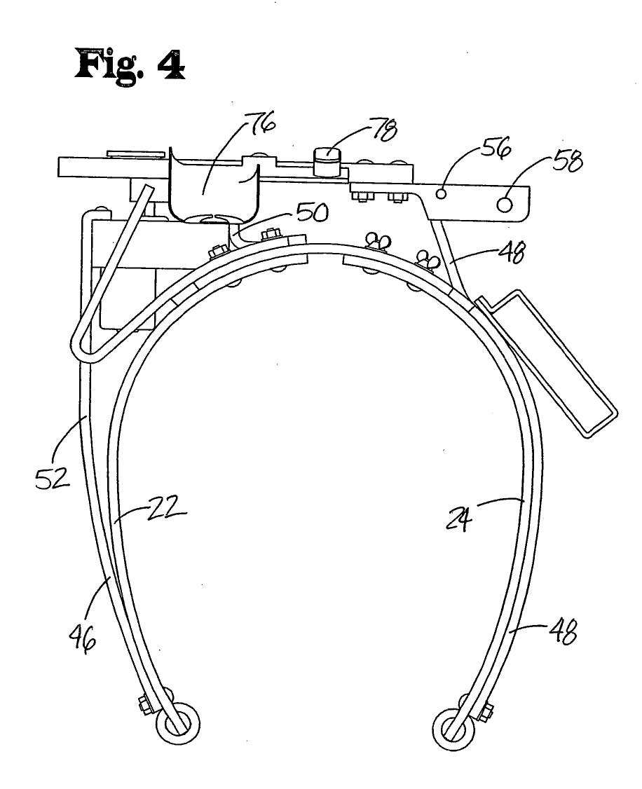

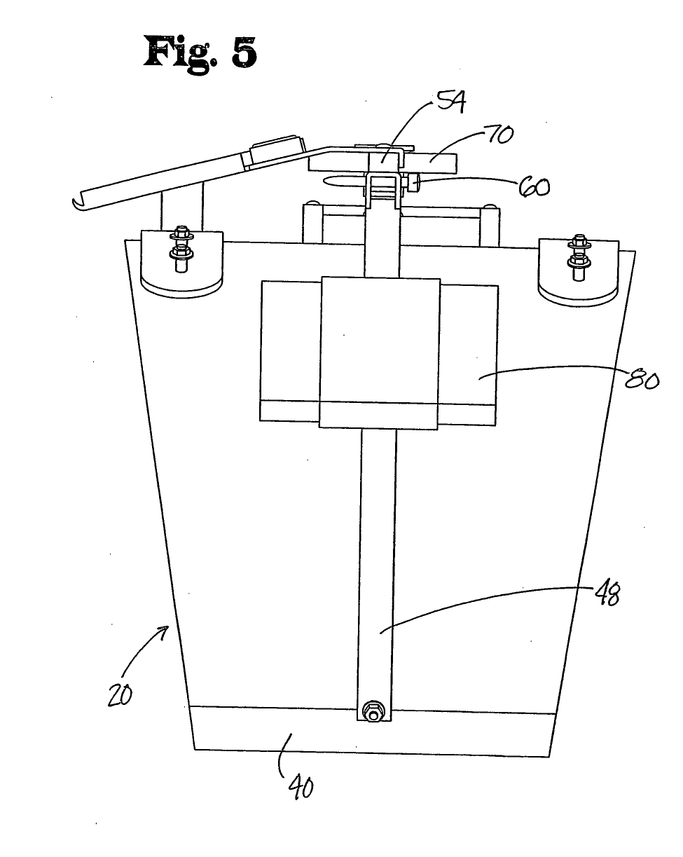

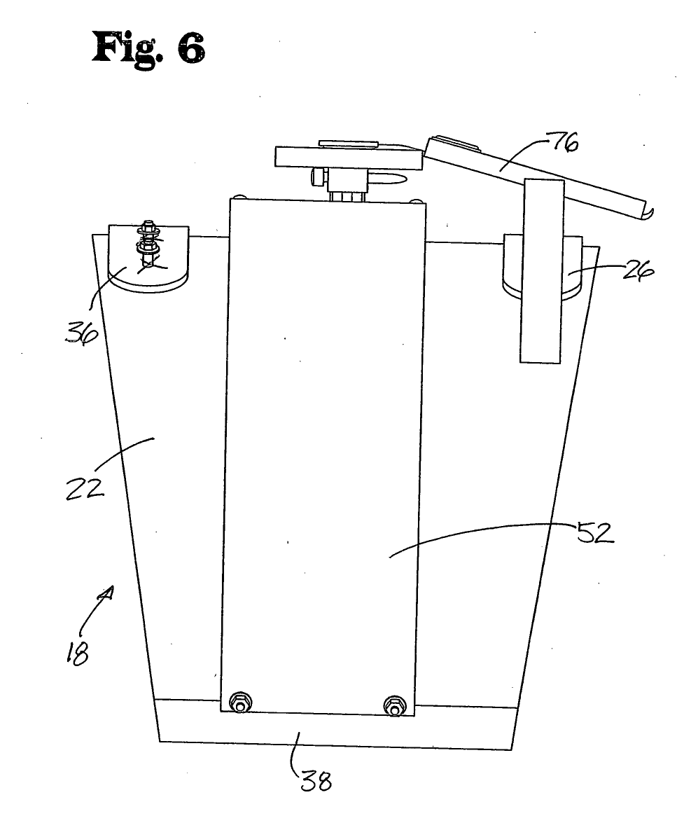

With reference now to the drawings, and in particular to FIGS. 1 through 6 thereof, a new sow stimulation saddle embodying the principles and concepts of the present invention and generally designated by the reference numeral 10 will be described.

The sow stimulation saddle system 10 of the invention is employed for stimulating a sow during the process of artificially inseminating the sow to enhance the opportunity for successful insemination. The saddle system 10 functions to enhance the artificial insemination process to increase the opportunities for successful insemination by simulating some of the conditions of a natural insemination, or mating, for the sow. The saddle system 10 generally functions to simulate the feel for the sow of some aspects of the mounted boar on the sow's back quarters, or loin, during the artificial insemination process.

In general, the sow insemination saddle system 10 comprises a saddle 12 for placing or positioning over a section of the loin or back of the sow, and an actuation structure 14 for causing movement of the saddle 10 on the back and loin of the sow that mimics the feel of the mounted boar.

In greater detail, the saddle 12 may comprise a generally horseshoe-shaped structure for encompassing a portion of the loin, or back of the sow. The saddle 12 may define an interior space 13 for receiving a middle portion of the torso of the sow. Preferably, but not critically, the saddle 12 reaches downwardly on the sides or flanks of the sow toward the belly. The saddle 12 may generally have a medial section 16 located between a pair of side sections 18, 20. Each of the side sections 18, 20 may have a lower end 19, 21, respectively. The side sections 18, 20 may extend from the medial section 16 in a substantially parallel relationship to each other, to thereby form the substantially horseshoe-shaped configuration.

In one embodiment of the invention, the lateral width of the saddle 12 may be extended and retracted to extend and contract the interior space 13 to accommodate the lateral girth of the sow. The saddle 12 may comprise a pair of side members 22, 24 to provide this functionality. The side members 22, 24 may be laterally adjustable to selectively increase and decrease a distance between the side members to thereby increase and decrease the lateral width of the interior space 13. The saddle 12 may include at least one connector 26 that connects the side members 22, 24 together in a manner that permits adjustment of the distance between the side members to achieve the increase and decrease in lateral width. The side members 22, 24 may each have an upper end 28, 30, and the upper ends of the side members may be effectively connected by the connector 26. The side members 22, 24 may each have an upper section 32, 34 that is located adjacent to the upper end 28, 30. The connector 26 may be mounted on the upper sections 32, 34 of the side members. In one embodiment of the invention, the connector 26 may be fixedly connected to the upper section 32 of one side member 22 and may be slidably connected to the upper section 34 of the other side member 24. In one embodiment, a pair of the connectors 26, 36 may be employed, and may be separated from each other along the upper ends 28, 30 of the side members 22, 24.

The saddle 12 may further include a shield member 38, 40 for increasing the comfort of the lower ends 19, 21 against the flank of the sow, as well as facilitating the mounting and dismounting of the saddle onto and off of the sow. The shield members 38, 40 may be mounted on the lower end 19, 21 of each of the side sections 18, 19. Each of the shield members 38, 40 may substantially enclose the lower end 19, 21 of the respective side sections 18, 19. In one embodiment of the invention, each shield member 38, 40 may form a channel 42 that receives the lower end 19, 21 of the respective side section 18, 19. Each shield member 38, 40 may define a slot into which a lower end portion of the respective side 18, 19 is inserted.

The saddle 12 is preferably formed of a substantially rigid but somewhat flexible material that permits a limited degree of bending of the saddle, but is sufficiently resilient to return to an initial shape once any deforming force is removed. A relatively light weight material is also desirable, but not critical. The material may be any material that exhibits these characteristics, and may comprise, for example, a polyvinyl chloride (PVC) plastic.

The saddle actuation structure 14 is located on the saddle 12 and moves the lower ends 19, 21 of the side sections 18, 20 of the saddle inwardly and outwardly with respect to each other. Preferably, the movement of the sections 18, 20 is a cyclical, repetitive movement. Preferably, the saddle actuation structure 14 flexes the sections 18, 20 of the saddle, rather than simply pivoting the sections with respect to each other, which could cause an uncomfortable pinching of the skin or localized compression of the body of the sow, although it should be understood that the invention could encompass a pivoting movement.

In greater detail, the actuation assembly 14 may include a frame assembly 44 that is mounted on the saddle 12. The frame assembly 44 may comprise a pair of side segments 46, 48 that are movable with respect to each other. Each of the side segments 46, 48 may be mounted on one of the side sections 18, 20 of the saddle 12. Thus, a first side segment 46 may be mounted on the first side section 18 of the saddle 12 and a second side segment 48 may be mounted on the second side section 20 of the saddle. Each of the side segments 46, 48 of the frame assembly may extend toward the lower end 19, 21 of the respective side section 18, 20 of the saddle. The first side segment 46 of the frame assembly 44 may include two parts, with a first part 50 being located toward the upper end 28 of the first side section 18 of the saddle and a second part 52 being located toward the lower end 19 of the first side section 18 of the saddle. The second part 52 of the first side segment 46 may extend toward the first part 50. Each of the side segments 46, 48 of the frame assembly 44 may be mounted on a respective one of the side members 22, 24 of the saddle.

The actuation assembly 14 may further include a linking segment 54 that functions to link the side segments 46, 48 of the frame assembly 44. The linking segment 54 may be attached to the side segments 46, 48 of the frame assembly. In one embodiment of the invention, the linking segment 54 may be releasably attached to the second side segment 48 of the frame assembly, so that the linking segment may be attached to at least two locations on the second side segment 48 of the frame assembly. A first one 56 of the attachment locations may be located laterally inward from a second one 58 of the attachment locations. The at least two locations 56, 58 for attachment between the linking segment 54 and the second side segment 48 permits the link to accommodate the adjustment of the lateral separation of the side members 22, 24 as described above to provide lateral adjustment of the interior space 13. The attachment of the linking segment 54 to the second side segment 48 may be accomplished through the use of a removable pin that may be inserted into one of two spaced holes on the linking segment 54 and also though a hole in the second side segment 48. A loop may be formed on the second side segment 48 to receive the pin 60.

The saddle actuation structure 14 may further comprise a motor assembly 62 for moving the side segments 46, 48 of the frame assembly 44 with respect to each other to move the side sections 18, 20 of the saddle 12 with respect to each other. The motor assembly 62 may be positioned between the first side segment 46 of the frame assembly and the linking segment 54 of the frame assembly. The motor assembly may comprise a motor structure 64 that is connected to the linking segment 54 and the first side segment 46 of the frame assembly 44. The motor structure 64 may have a housing and a rotatable shaft, and may also include a gear reduction case 66 that is connected to the rotatable shaft of the motor for reducing a speed of the shaft rotation. The gear reduction structure 66 may have a stub shaft 68 rotatable at a speed that is a fraction of the speed of the shaft of the motor.

The linking segment 54 may include an eccentric motion structure 70 that is connected to the motor such that operation of the motor causes an eccentric motion of the eccentric motion structure 70. Illustratively, the eccentric motion structure 70 may have two parts, a first part 72 being connected to the linking segment 54 of the frame assembly 44 and a second part 74 being connected to the shaft of the motor, or the stub shaft 69 of the gear reduction case if employed. The first part 72 may comprise a disk that is mounted on the shaft 68 of the motor such that rotation of the shaft of the motor causes the disk to rotate in an eccentric manner with respect to the shaft 68. The second part 74 may comprise a captive housing in which the disk is captured, so that rotation of the motor shaft and disk in the captive housing causes the first side segment 46, and the combination of the linking segment 54 and the second side segment 48 to move closer together and then away from each other in a cyclical, rhythmic manner that not only moves the side segments of the frame assembly towards and away from each other, but also the side section 18, 20 of the saddle to produce the aforedescribed alternate inward and outward motion of the lower ends 19, 20 of the saddle.

Optionally, the system may further include an insemination tube support 76 for supporting the tube of semen during the insemination process, so that the tube does not need to be independently supported. Further, a power switch 78 may be provided for controlling the supply of power to the motor. Also, the system 10 may also include a rechargeable battery 80 that may be employed to supply power to the motor for a period of time without having to directly plug the motor into a wall power outlet. Further, the system 10 may include means for directly connecting the system to a power outlet to operate the motor or recharge the battery. The means may be adapted to connect to a 120 Volt power source, or to a 12 V power source, such as is typically available in a vehicle.

In use, the side sections 18, 20 of the saddle 12 are slipped over the back of the sow so that the side sections are positioned adjacent to the flanks of the loin of the sow. The motor is turned on, and the side segments of the frame assembly, as well as the side sections 18, 20 of the saddle, are reciprocated.

With respect to the above description then, it is to be realized that the optimum dimensional relationships for the parts of the invention, to include variations in size, materials, shape, form, function and manner of operation, assembly and use, are deemed readily apparent and obvious to one skilled in the art in light of the foregoing disclosure, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A sow stimulation saddle system for stimulating a sow during artificial insemination, the sow insemination saddle system comprising:
a saddle for placing over a section of the loin of a sow for encompassing a portion of the loin, the saddle having a medial section between a pair of side sections, each of the side sections having a lower end;
an actuation structure on the saddle for moving the lower ends of the side sections of the saddle inwardly and outwardly with respect to each other.

2. The system of claim 1 wherein the actuation assembly comprising
a frame assembly mounted on the saddle; and
a motor assembly for moving the side segments of the frame with respect to each other to move the side sections of the saddle with respect to each other.

3. The system of claim 2 wherein the frame assembly comprises:
a pair of side segments movable with respect to each other, each of the side segments being mounted on one of the side sections of the saddle, a first one of the side segments being mounted on the first side section of the saddle and a second one of the side segments being mounted on the second side section of the saddle; and
a linking segment linking the side segments of the frame assembly.

4. The system of claim 2 wherein the motor assembly comprises an eccentric motion structure connected to the motor such that operation of the motor causes an eccentric motion of the eccentric motion structure and thereby causes a reciprocating motion of the side sections of the saddle.

5. The system of claim 1 wherein the saddle comprises a pair of side members forming portions of the side sections of the saddle, the side members being laterally adjustable to selectively increase and decrease a distance between the side members.

6. The system of claim 5 wherein the saddle includes at least one connector connecting the side members together in a manner that permits adjustment of the distance between the side members.

7. The system of claim 1 additionally comprising a shield member being mounted on the lower end of each of the side sections.

8. The system of claim 1 wherein each shield member encloses the lower end of the respective side section.

9. The system of claim 1 wherein the saddle is formed of a substantially rigid but somewhat flexible material, the material being resilient.

10. The system of claim 1 wherein the actuation assembly comprising
a frame assembly mounted on the saddle; and
a motor assembly for moving the side segments of the frame with respect to each other to move the side sections of the saddle with respect to each other;
wherein the frame assembly comprises:
a pair of side segments movable with respect to each other, each of the side segments being mounted on one of the side sections of the saddle, a first one of the side segments being mounted on the first side section of the saddle and a second one of the side segments being mounted on the second side section of the saddle; and
a linking segment linking the side segments of the frame assembly;
wherein the motor assembly comprises an eccentric motion structure connected to the motor such that operation of the motor causes an eccentric motion of the eccentric motion structure and thereby causes a reciprocating motion of the side sections of the saddle;
wherein the saddle comprises a pair of side members forming portions of the side sections of the saddle, the side members being laterally adjustable to selectively increase and decrease a distance between the side members;
wherein the saddle includes at least one connector connecting the side members together in a manner that permits adjustment of the distance between the side members;
a shield member being mounted on the lower end of each of the side sections;
wherein each shield member encloses the lower end of the respective side section;
wherein the saddle is formed of a substantially rigid but somewhat flexible material, the material being resilient.

11. A method of inseminating a sow, comprising:
placing a sow stimulation saddle system on the loin of a sow so that the saddle system contacts the flanks of the sow;
alternately applying pressure on, and releasing the pressure from, the flanks of the sow by the saddle system; and
administering semen to the sow as pressure is applied to and released from the flanks of the sow.
